(19) United States
(12) Patent Application Publication
(10) Pub. No.: US 2023/0359965 A1
(43) Pub. Date: Nov. 9, 2023

(54) METHODS, INTERNET OF THINGS (IOT) SYSTEMS, AND MEDIA FOR DYNAMICALLY ADJUSTING LNG STORAGE BASED ON BIG DATA

(71) Applicant: CHENGDU PUHUIDAO SMART ENERGY TECHNOLOGY CO., LTD., Chengdu (CN)

(72) Inventor: Lin FU, Chengdu (CN)

(73) Assignee: CHENGDU PUHUIDAO SMART ENERGY TECHNOLOGY CO., LTD., Chengdu (CN)

(21) Appl. No.: 18/306,199

(22) Filed: Apr. 24, 2023

(30) Foreign Application Priority Data
May 7, 2022 (CN) 202210491999.9

(51) Int. Cl. G06Q 10/0631; G06Q 10/087; G06Q 50/06

(52) U.S. Cl. CPC G06Q 10/06315; G06Q 10/087; G06Q 50/06

(57) ABSTRACT

The embodiments of the present disclosure provide a method, an Internet of Things system, and a medium for dynamically adjusting LNG storage based on big data. The method includes: setting up LNG intelligent gas supply terminals at user gas supply points to collect LNG storage volume; real-time monitoring and collecting storage volume data; importing the geographical location information of LNG storage stations and LNG intelligent gas supply terminals into a GIS map, and forming a virtual pipeline network for LNG supply on the map according to the relationships of geographical locations; dividing supply areas with LNG storage stations as the centers; and obtaining the total amount of consumption, consumption peaks, consumption troughs, consumption rates, and the remaining storage amount of LNG in different supply areas using statistical analysis to form LNG storage strategies.

### CROSS REFERENCE TO RELATED APPLICATIONS

This application claims priority of the Chinese Patent Application No. 202210491999.9, filed on May 7, 2022, the contents of which are incorporated herein by reference.

### TECHNICAL FIELD

The present disclosure relates to the technical fields of Internet of Things and big data, in particular to a method, an Internet of Things (IoT) system, and a medium for dynamically adjusting LNG storage based on big data.

### BACKGROUND

The emergence of liquefied natural gas (LNG) has revolutionized the energy mix of natural gas, enabling the use of natural gas depending on natural gas storage and transportation equipment without pipeline transmission, thereby meeting the needs of a wider variety of users. For example, small and medium-sized towns and enterprises that are far away from cities or natural gas pipelines but consume a lot of energy may not be able to use pipeline natural gas for gas supply. In this case, LNG becomes their main or transitional gas source. At the same time, LNG is also a supplementary gas source or peak-shaving gas source for many cities that use pipeline natural gas for gas supply.

An LNG storage station is a satellite station for receiving, storing, and distributing LNG, and it is also an intermediate adjustment place for towns or gas companies to transfer LNG from manufacturers to users. The operation and management of LNG supply, transmission, and distribution processes involve not only the consideration of meeting the needs of users for normal use, but also the laying of the right amount of equipment, maintaining management, and controlling costs as much as possible in relation to the density of the user gathering. For business operators, it is also necessary to control the pressure of LNG storage to prevent great loss of equipment and energy, which leads to higher costs and wasted resources.

At present, the process of LNG supply, transmission, and distribution lacks standardized, intelligent, and platform-based management. Therefore, a method, an IoT system, and a medium for dynamically adjusting LNG storage based on big data is needed to improve the intelligent and platform-based management of LNG and reduce costs.

### SUMMARY

One or more embodiments of the present disclosure provide a method for dynamically adjusting LNG storage based on big data. The method includes the following steps: step 1: setting up LNG intelligent gas supply terminals at gas supply points of all users to collect real-time LNG storage data and uploading the real-time LNG storage data through a wireless sensing network; step 2: monitoring LNG storage stations in real-time, and uploading the storage volume data through the wireless sensor network; step 3: importing geographical location information of the LNG storage stations and the LNG intelligent gas supply terminals into a geographic information system (GIS) map, and forming a virtual pipeline network for LNG supply according to a geographic location relationship between the LNG storage stations and the LNG intelligent gas supply terminals; step 4: dividing supply areas with the LNG storage stations as the centers according to the virtual pipeline network on the map; and step 5: by statistically analyzing data collected by the LNG intelligent gas supply terminals and the storage volume data of the LNG storage stations, obtaining a total amount of consumption, high consumption peaks, low consumption peaks, consumption rates, and remaining storage amount of LNG in different supply areas, so as to form LNG storage strategies.

One of the embodiments of the present disclosure provides an IoT system for dynamically adjusting LNG storage based on big data, which adopts the method of dynamically adjusting LNG storage based on big data, including an LNG distributed energy operator user platform, an LNG distributed energy service platform, an LNG distributed energy integrated management platform, a plurality of sensing network platforms and a plurality of object platforms; the LNG distributed energy operator user platform, the LNG distributed energy service platform, the LNG distributed energy integrated management platform, the plurality of sensing network platforms and the plurality of object platforms are connected in sequence by communication; the LNG distributed energy operator user platform is configured for operator users to obtain LNG storage sensing information and LNG consumption sensing information, and to release corresponding control information as required; the LNG distributed energy service platform is a server, which connects the LNG distributed energy operator user platform and the LNG distributed energy integrated management platform through a communication network; the LNG distributed energy integrated management platform is configured to call LNG storage information and LNG consumption information, and through centralized calculation of big data, comprehensively analyze the total amount of LNG consumption, consumption peaks, consumption troughs, consumption rates, and the remaining storage amount of LNG in different areas to form LNG storage strategies; the sensing network platform includes an LNG distributed energy storage sensing network platform and an LNG distributed energy intelligent terminal sensing network platform; the LNG distributed energy storage sensing network platform is connected to the LNG distributed energy storage object platform for realizing the communication connection between the LNG distributed energy integrated management platform and the LNG distributed energy storage object platform by means of a sensing communication network; the LNG distributed energy intelligent terminal sensing network platform is connected to the LNG distributed energy intelligent terminal object platform for realizing the communication connection between the LNG distributed energy integrated management platform and the LNG distributed energy intelligent terminal object platform by means of the sensing communication network; the object platform comprises the LNG distributed energy storage object platform and the LNG distributed energy intelligent terminal object platform; and the object platform is used for collecting and uploading sensing information of storage and intelligent gas supply terminals, and for executing control commands corresponding to the LNG storage strategies formed by the LNG distributed energy integrated management platform.

One or more embodiments of the present disclosure provide a non-transitory computer-readable storage medium, the storage medium storing computer commands, and when the computer reads the computer commands in the storage medium, the computer executes the aforementioned method of dynamically adjusting LNG storage based on big data.

### BRIEF DESCRIPTION OF THE DRAWINGS

The present disclosure will be further illustrated by way of exemplary embodiments, which will be described in detail with the accompanying drawings. These examples are non-limiting, and in these examples, the same number indicates the same structure, wherein:

FIG. 1 is an exemplary flowchart of the method for dynamically adjusting LNG storage based on big data according to some embodiments of the present disclosure;

FIG. 2 is an exemplary schematic diagram of forming a virtual pipeline network according to some embodiments of the present disclosure;

FIG. 3 is an exemplary schematic diagram of a storage sub-strategy model according to some embodiments of the present disclosure;

FIG. 4 is an exemplary schematic diagram of a prediction model according to some embodiments of the present disclosure;

FIG. 5 is an exemplary schematic diagram of a virtual pipeline network according to some embodiments of the present disclosure; and

FIG. 6 is an exemplary schematic diagram of an Internet of Things system for dynamically adjusting LNG storage based on big data according to some embodiments of the present disclosure.

### DETAILED DESCRIPTION

In order to more clearly illustrate the technical solutions of the embodiments of the present disclosure, the following briefly introduces the drawings that need to be used in the description of the embodiments. Apparently, the accompanying drawings in the following description are only some examples or embodiments of the present disclosure, and those skilled in the art can also apply the present disclosure to other similar scenarios. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, parts or assemblies of different levels. However, the words may be replaced by other expressions if other words can achieve the same purpose.

As indicated in the disclosure and claims, the terms “a”, “an”, “an” and/or “the” are not specific to the singular form and may include the plural form as well unless the context clearly indicates an exception. Generally speaking, the terms “comprise”, “comprises”, “comprising”, “include”, “includes”, and/or “including” only suggest the inclusion of clearly identified steps and elements, and these steps and elements do not constitute an exclusive list. The method or device may also contain other steps or elements.

The flowchart is used in the present disclosure to illustrate the operations performed by the system according to the embodiment of the present disclosure. It should be understood that the preceding or following operations are not necessarily performed in the exact order. Instead, various steps may be processed in reverse order or simultaneously. At the same time, other operations can be added to these procedures, or a certain step or steps can be removed from these procedures.

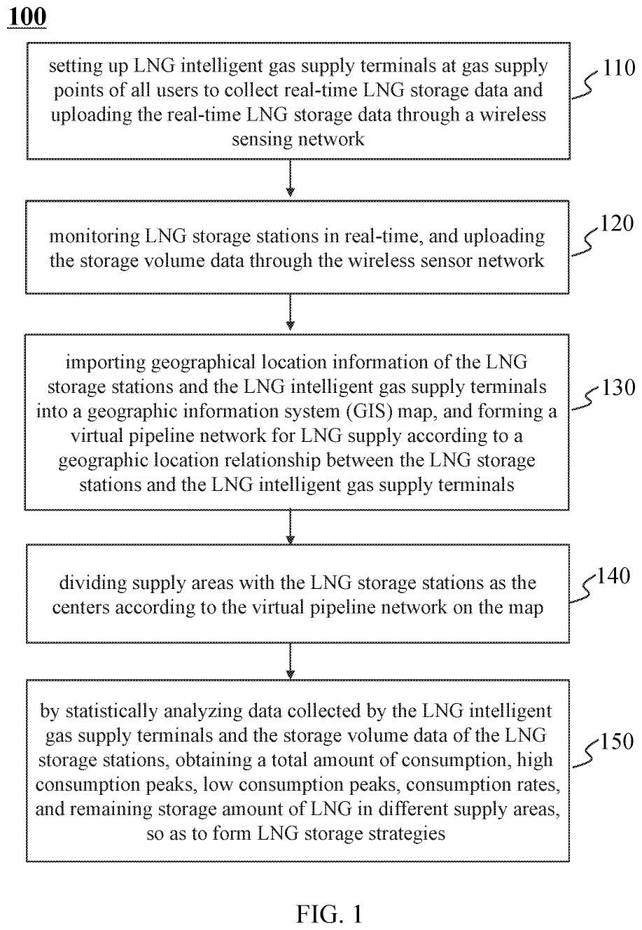

FIG. 1 is an exemplary flowchart of the method for dynamically adjusting LNG storage based on big data according to some embodiments of the present disclosure. In some embodiments, a process 100 may be performed by an LNG distributed energy integrated management platform 630. As shown in FIG. 1, the process 100 includes the following steps.

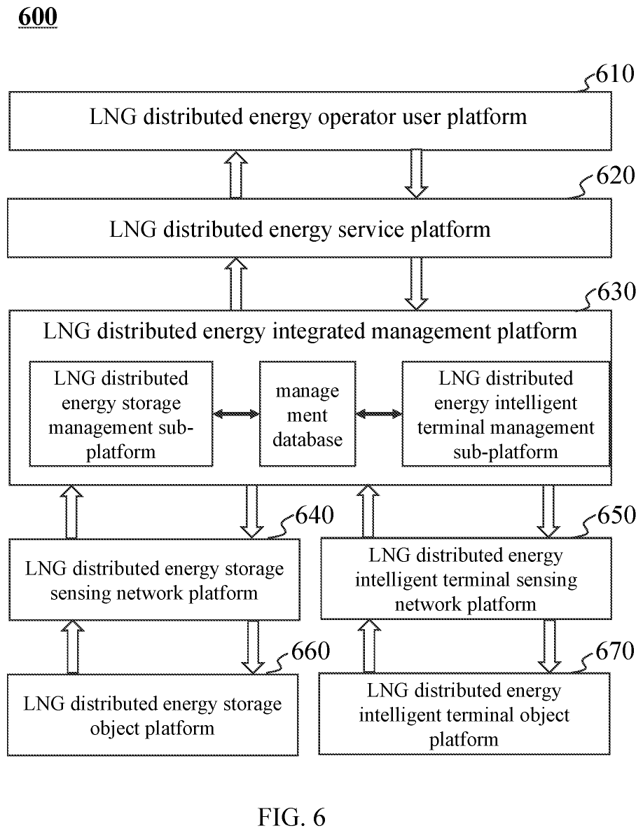

In some embodiments, the method for dynamically adjusting LNG storage based on big data can be applied to the IoT system in FIG. 6.

Step 110: setting up LNG intelligent gas supply terminals at gas supply points of all users to collect real-time LNG storage data and uploading the real-time LNG storage data through a wireless sensing network;

Gas supply points of all users refer to all points that need to provide LNG to users.

LNG intelligent gas supply terminals refer to terminals with intelligent characteristics that provide LNG to users, such as the ability to automatically monitor parameters such as LNG flows, pressures, and storage volume data and upload them to the network, etc. The LNG intelligent gas supply terminals may include LNG storage tanks.

LNG storage volume data refer to the relevant data reflecting the LNG remaining storage amount in the LNG intelligent gas supply terminals.

In some embodiments, the LNG intelligent gas supply terminals may collect LNG storage volume data in real-time through their incorporated metering and sensing systems, and upload LNG storage volume data to the LNG distributed energy integrated management platform through their incorporated communication modules.

Step 120: monitoring the storage volume data of the LNG storage stations in real-time and uploading them via the wireless sensing network.

LNG storage stations refer to the sites for storing and transmitting LNG.

Storage volume data refer to relevant data reflecting the storage volume of LNG in the LNG storage stations.

Step 130: importing the geographic location information of the LNG storage stations and the LNG intelligent gas supply terminals into the GIS map, and forming a virtual pipeline network for LNG supply on the map based on the geographic location relationship between the LNG storage stations and the LNG intelligent gas supply terminals.

The virtual pipeline network refers to the virtual network of pipelines for LNG transmission. Exemplarily, the virtual pipeline network may include at least one LNG storage station, at least one LNG intelligent gas supply terminal, a connection line between each LNG storage station and the LNG intelligent gas supply terminal receiving the supply from that LNG storage station, etc.

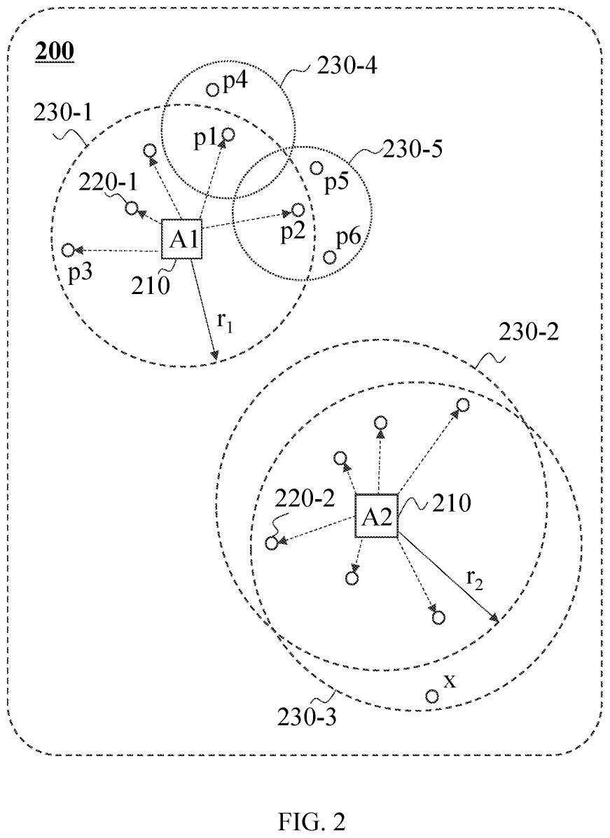

For more information about the virtual pipeline network, see FIG. 2 and its related descriptions.

An LNG distributed energy integrated management platform 630 may form a virtual pipeline network for LNG supply on the map by various feasible methods based on the geographic relationship between LNG storage stations and LNG intelligent gas supply terminals. For example, the LNG distributed energy integrated management platform 630 may, based on the geographical location relationship between the LNG intelligent gas supply terminals and the LNG storage stations, determine an LNG storage station with the highest delivery efficiency reaching the LNG intelligent gas supply terminals and connect the LNG storage station to the LNG intelligent gas supply terminals through connecting lines to form a virtual pipeline network for LNG supply on the map.

In some embodiments, when there are two or more LNG storage stations with the highest delivery efficiency reaching the LNG intelligent gas supply terminals, the priority LNG storage station may be determined based on the size characteristics of the two or more LNG storage stations and the gas consumption characteristics of all LNG intelligent gas supply terminals corresponding to each LNG storage station in the supply relationship, and connect the priority LNG storage station to the LNG intelligent gas supply terminals via connecting lines.

For more information on the size characteristics and gas consumption characteristics, please refer to FIG. 2 and its related descriptions.

In some embodiments, the virtual pipeline network is configured to map the supply relationship between the LNG storage stations and the LNG intelligent gas supply terminals.

In some embodiments, the virtual pipeline network is configured to map the supply relationship between the LNG storage stations and the LNG intelligent gas supply terminals, i.e. to form the LNG storage station—virtual pipeline network—LNG intelligent gas supply terminals at each supply point in each area. In practice, the routes of the virtual pipeline network in different areas on the map can be distinguished by different colors.

The supply relationship refers to the correspondence between the LNG storage stations and the LNG intelligent supply terminals receiving LNG from that LNG storage stations.

In some embodiments, step 130 includes the following sub-steps:

step 301: obtaining the geographic location information of all the LNG storage stations and the LNG intelligent gas supply terminals and importing them into the GIS map; and

step 302: locating the LNG storage station with a shortest route to the LNG intelligent gas supply terminals, and connecting this LNG storage station to the LNG intelligent gas supply terminals via routes on the GIS map, thereby forming the virtual pipeline network on the map for LNG supply.

In some embodiments, the LNG distributed energy integrated management platform 630 may calculate the distances between each LNG storage station and the LNG intelligent gas supply terminals by using the geographic location information of all LNG storage stations and LNG intelligent gas supply terminals and selecting the LNG storage station corresponding to the smallest value of the distance as the LNG storage station with the shortest route.

In some embodiments, the LNG distributed energy integrated management platform 630 may map routes through interfaces provided by geographic information system software such as ArcGIS to connect the LNG intelligent gas supply terminal(s) to the LNG storage station(s) with the shortest route.

In some embodiments, step 130 includes the following sub-steps:

step 301: obtaining the geographical location information of all LNG storage stations and LNG intelligent gas supply terminals, and importing them into the GIS map;

step 302: locating an LNG storage station with the shortest transportation time required for LNG intelligent gas supply terminals to obtain LNG, and connecting this LNG storage station to the LNG intelligent gas supply terminals through the transportation routes on the map, forming a virtual pipeline network for LNG supply on the map.

For more information on forming a virtual pipeline network, refer to FIG. 2 and its related descriptions.

In some embodiments, the LNG distributed energy integrated management platform 630 may obtain the arrival time from each LNG storage station to an LNG intelligent gas supply terminal through the interface provided by geographic information system software such as ArcGIS based on the geographic location information of all LNG storage stations and LNG intelligent gas supply terminals, select an LNG storage station having the smallest arrival time, and draw a route on the map to connect the LNG intelligent gas supply terminal to the LNG storage station with the shortest arrival time.

Step 140: dividing the supply areas with the LNG storage stations as the centers based on the virtual pipeline network on the map.

The supply areas refer to the areas covered by the supply relationship of the LNG storage stations.

In some embodiments, the integrated LNG distributed energy management platform 630 may divide the connected LNG storage stations and LNG intelligent gas supply terminals in the virtual pipeline network into the same supply area.

Step 150: by statistically analyzing the data collected by the LNG intelligent gas supply terminals and the storage volume data of the LNG storage stations, obtaining the total amount of consumption, high consumption peaks, low consumption peaks, consumption rates, and remaining storage amount of LNG in different supply areas, thereby forming LNG storage strategies.

The LNG distributed energy integrated management platform 630 may perform statistical analysis on the data collected by the LNG intelligent gas supply terminals and the storage volume data of the LNG storage stations through various feasible methods. Exemplarily, the LNG distributed energy integrated management platform 630 may obtain the LNG storage volume data collected by the LNG intelligent gas supply terminals and the storage volume data of the LNG storage stations, and aggregate them according to the supply areas and different preset statistical time periods (e.g., hourly, daily, weekly, etc.), and then obtain the total amount of consumption, high consumption peaks, low consumption peaks, consumption rates, and remaining storage amount, etc. based on the changes of the LNG storage volume data and the storage volume data of the LNG intelligent gas supply terminals and that of the LNG storage stations respectively within the preset statistical time periods, which can be used to reflect the LNG consumption situations in the supply areas.

LNG storage strategies refer to the relevant strategies and measures of LNG storage management. Exemplary LNG storage strategies may include storage tank management strategies (e.g., count of storage tanks, specifications, etc.), supply chain management strategies (e.g., times and methods for gas replenishment, etc.), logistics management strategies (e.g., logistics network planning, etc.), or the like.

The LNG distributed energy integrated management platform 630 may form LNG storage strategies through various feasible methods, for example, it may determine the amount of replenishment gas needed at LNG storage stations based on the total amount of LNG consumption and the remaining storage amount in each supply area, and then increase or decrease the amount of replenishment gas according to the time points of high consumption peaks or low consumption peaks as well as the trends of consumption rates to form LNG storage strategies.

In some implementations, the total amount of LNG consumption at the supply points can be obtained based on the changes in the real-time LNG storage volume collected by the intelligent gas supply terminals, and the total amount and rate of consumption can be obtained by adding up the total amount of LNG consumption at all the intelligent gas supply terminals supplied by the LNG storage stations. Similarly, high consumption peaks and low consumption peaks can be obtained by analyzing consumption at different times, and the remaining storage amount of the LNG storage stations can be adjusted based on the total amount of consumption, high consumption peaks, low consumption peaks, and consumption rates, thus ensuring that there is no shortage of supply.

The present disclosure provides statistical analysis of users' gas consumption using big data analysis, which facilitates operators' management by visualizing users' gas consumption and thus providing directions for analysis of storage strategies. When new user points are added, they can be incorporated into the existing management system at a minimal cost, which not only ensures users' normal use of gas but also saves management and maintenance costs economically.

It should be noted that the above descriptions of the process 100 are only for illustration and description, and do not limit the scope of application of the present disclosure. For those skilled in the art, various modifications and changes can be made to the process 100 following the guidance of the present disclosure. However, such modifications and changes are still within the scope of the present disclosure.

FIG. 2 is an exemplary schematic diagram of forming a virtual pipeline network according to some embodiments of the present disclosure.

In some embodiments, the LNG distributed energy integrated management platform 630 may determine the supply relationship network according to the size characteristics of each LNG storage station and the gas consumption characteristics of each LNG intelligent gas supply terminal, and form a virtual pipeline network on the map according to the supply relationship network.

Size characteristics refer to the relevant characteristics that can characterize the sizes of LNG storage stations. In some embodiments, size characteristics can be represented by vectors. One or more elements of the vectors may represent one or more of the categories of users (e.g., industrial, transportation, residential, etc.), the number of customers supplied, the gas consumption indexes, the total volume of storage tanks, or the like, respectively. Size characteristics can also be expressed by scale, such as small, medium, large, etc.

The gas consumption characteristics refer to the relevant characteristics of the LNG consumption of the LNG intelligent gas supply terminals. In some embodiments, gas characteristics may be represented by vectors. The elements in the vectors may include historical gas consumption data of the LNG intelligent gas supply terminals, as well as the estimated gas consumption data of the LNG intelligent gas supply terminals.

In some embodiments, the integrated LNG distributed energy management platform 630 may obtain estimated gas consumption data by a fitting relationship based on estimated gas consumption times. The fitting relationship can be obtained by fitting the historical gas consumption data and historical gas consumption times.

The supply relationship network refers to the network formed based on the supply relationships. For more on supply relationships, see FIG. 1 and its associated descriptions.

In some embodiments, the supply relationship network includes supply storage stations corresponding to each of the LNG intelligent gas supply terminals.

The LNG distributed energy integrated management platform 630 may determine the supply relationship network in various feasible ways based on the size characteristics of each LNG storage station and the gas consumption characteristics of each LNG intelligent gas supply terminal. For example, the supply relationship network can be determined based on the size characteristics of each LNG storage station, the gas consumption characteristics of each LNG intelligent gas supply terminal, and a preset supply relationship mapping table. The supply relationship mapping table may include various combinations of different size characteristics with different gas consumption characteristics, as well as pre-set radii of the corresponding supply relationship networks in different scenarios. The LNG distributed energy integrated management platform 630 may connect LNG intelligent gas supply terminals around an LNG storage station within the radius of a supply relationship network to form a supply relationship network.

In some embodiments, the LNG distributed energy integrated management platform 630 may cluster the LNG intelligent gas supply terminals around an LNG storage station using a density-based clustering algorithm to establish a connection relationship between the LNG intelligent gas supply terminals satisfying the pre-set conditions and the LNG storage station to form a supply relationship network, wherein the density threshold value of the density-based clustering algorithm may be related to the size characteristics of the LNG storage station and the gas consumption characteristics of the LNG intelligent gas supply terminals.

In some embodiments, the density-based clustering algorithm may include at least one of a minimum density threshold or a maximum density threshold. The minimum density threshold can be determined based on historical experience (the minimum density threshold may group areas with sufficiently high density together). The maximum density threshold may be set as the total volume of the LNG storage tanks divided by the average daily consumption of the LNG intelligent gas supply terminals. The maximum density threshold can be used to limit the count of LNG intelligent gas supply terminals supplied by an LNG storage station based on the LNG storage station's supply capacity.

In some embodiments, with a geographic location of an LNG storage station as a center, an area with a radius of a first pre-set initial distance (e.g., distance ra, distance rb) may be determined as an initial coverage area of the LNG storage station, and a plurality of LNG intelligent gas supply terminals within the initial coverage area may be determined as a plurality of candidate gas supply points. A density-based clustering algorithm may be used to detect whether the density of the LNG intelligent gas supply terminals in the initial coverage area is greater than the maximum density threshold for that LNG storage station. In response to being below the maximum density threshold, a terminal collection corresponding to the LNG storage station is established, the plurality of LNG intelligent gas supply terminals are added to the terminal collection, and the LNG intelligent gas supply terminals in the terminal collection are connected to the LNG storage station to form a supply relationship network.

The density-based clustering algorithms may include Density Peak Clustering (DPC), Density-based Dual Threshold Clustering (DDTC), Density-based Spatial Clustering for Noise Applications (DBSCAN), etc.

Exemplarily, as shown in FIG. 2, the LNG storage station 210 includes a storage station A1, and the first pre-set initial distance of the storage station A1 is r1, corresponding to an initial coverage area 230-1. Based on the size characteristics of the storage station A1 (e.g., small) and the gas consumption characteristics of the plurality of LNG intelligent gas supply terminals 220-1 in the initial coverage area 230-1, the maximum density threshold of storage station A1 can be determined as p1.

A density-based clustering algorithm is used to detect whether the density of LNG intelligent gas supply terminals within the initial coverage area 230-1 is greater than the maximum density threshold p1. In response to being below the maximum density threshold p1, the plurality of LNG intelligent gas supply terminals 220-1 in the initial coverage area 230-1 are added to the terminal collection corresponding to the storage station A1, and the LNG intelligent gas supply terminals in the terminal collection are connected to the storage station A1 to form a supply relationship network.

In some embodiments, the first pre-set initial distance may be gradually increased and the terminal collection may be determined several times until the density of LNG intelligent gas supply terminals in the coverage area corresponding to the first pre-set initial distance is greater than or equal to the maximum density threshold.

In some embodiments, a plurality of candidate coverage areas of the LNG storage station may be determined, and a relatively better candidate coverage area may be selected as the initial coverage area. For example, among the plurality of candidate coverage areas, within the supply capacity of the LNG storage station (e.g., not exceeding the maximum density threshold), the candidate coverage area with a larger count of LNG intelligent gas supply terminals can be a relatively better candidate coverage area.

Exemplarily, as shown in FIG. 2, the LNG storage station 210 includes a storage station A2. A pre-set number (e.g., 50, 100, etc.) of circular candidate coverage areas with a first pre-set initial distance r2 as a radius and including the geographic coordinates of the storage station A2 (not necessarily the center of the circle) are determined, e.g., a candidate coverage area 230-2 and a candidate coverage area 230-3. Within each candidate coverage area in a pre-set number, the plurality of LNG intelligent gas supply terminals 220-2 in the area are identified as the plurality of candidate gas supply points.

A density-based clustering algorithm is used to detect whether the density of LNG intelligent gas supply terminals in each candidate coverage area is greater than the maximum density threshold p2 of the storage station A2. In response to being below the maximum density threshold p2, the plurality of LNG intelligent gas supply terminals in each candidate coverage area is added to the terminal collection corresponding to that candidate coverage area, and the actual density corresponding to each candidate coverage area is recorded. The value of the actual density is the number of LNG intelligent gas supply terminals in each candidate coverage area.

The actual density of candidate coverage areas in a pre-set number are compared, and the candidate coverage area with the largest actual density is selected as the initial coverage area. A connection relationship between the LNG intelligent gas supply terminals in the terminal collection corresponding to the initial coverage area and the storage station A2 is established to form a supply relationship network.

As shown in FIG. 2, the actual density of the candidate coverage area 230-3 (with an additional LNG intelligent gas supply terminal x than the coverage area of candidate coverage area 230-2) is greater than the actual density of the candidate coverage area 230-2, so the candidate coverage area 230-3 is selected as the initial coverage area.

Thereby, some embodiments of the present disclosure can optimize the determination of the initial coverage area to meet the demand of as many LNG intelligent gas supply terminals as possible within the supply capacity of the LNG storage station.

In some embodiments, one may also identify a plurality of LNG intelligent gas supply terminals in the terminal collection as candidate gas supply points based on the terminal collection, determine the candidate gas supply points satisfying an expansion condition as the expanded gas supply points, expand gas supply areas on the basis of the expanded gas supply points, thereby expanding the terminal collection of the LNG storage stations. The expansion condition may be set as follows: the calculated distances between two of the candidate gas supply points in the terminal collection is less than a pre-set distance threshold (the pre-set distance threshold can be determined based on the probability distribution of the distance between two of the candidate gas supply points).

For example, as shown in FIG. 2, if the distance between LNG intelligent gas supply terminal p1 and LNG intelligent gas supply terminal p2 is less than a pre-set distance threshold, while the distance between LNG intelligent gas supply terminal p1 and LNG intelligent gas supply terminal p3, and the distance between LNG intelligent gas supply terminal p2 and LNG intelligent gas supply terminal p3 are greater than a pre-set distance threshold, then LNG intelligent gas supply terminal p1 and LNG intelligent gas supply terminal p2 can be expanded gas supply points.

Thereby, some embodiments of the present disclosure can optimize the expansion direction of the coverage areas of the LNG storage stations, and within the supply capacity of the LNG storage stations, expand the coverage areas of the LNG storage stations towards directions where the LNG intelligent gas supply terminals are more concentrated, which is conducive to improving the efficiency of LNG transmission and supply.

In some embodiments, a plurality of expanded gas supply areas of the LNG storage stations may be determined with at least one of the identified expanded gas supply points in the terminal collection as the center and a second pre-set initial distance as the radius, respectively. The LNG intelligent gas supply terminals other than the expanded gas supply points in the terminal collection in each expanded gas supply area are identified as extended gas supply points and the count of extended gas supply points in each expanded gas supply area is calculated respectively. The expanded gas supply areas are ranked according to the count of extended gas supply points. According to the ranking, the sum of the count of extended supply points in the expanded supply area with the highest ranking (e.g., the largest count of extended supply points) and the count of LNG intelligent supply terminals in the terminal collection is calculated, and it is determined whether the sum is greater than the maximum density threshold of the LNG storage station. In response to the added sum being below the maximum density threshold of the LNG storage terminals, the extended gas supply points within the expanded gas supply area are added to the terminal collection.

In some embodiments, the sum of the count of extended supply points in the next (e.g., second in order of the count of extended supply points) expanded supply area and the count of LNG intelligent supply terminals in the terminal collection may be further calculated sequentially, and a determination may be made as to whether the sum is greater than the maximum density threshold for that LNG storage station. In response to the added sum being below the maximum density threshold of the LNG storage station, add the extended gas supply point within the expanded gas supply area to the terminal collection. In response to the sum being greater than the pre-set maximum density threshold of the storage station, stop expanding the collection of LNG storage station terminals.

Exemplarily, as shown in FIG. 2, a plurality of expanded gas supply areas of the LNG storage station, including expanded gas supply area 230-4 and expanded gas supply area 230-5, are determined with the identified expanded gas supply point (e.g., LNG intelligent gas supply terminal p1 and LNG intelligent gas supply terminal p2 in the terminal collection) as the center respectively and the second pre-set initial distance as the radius. The expanded gas supply area 230-4 corresponding to the LNG intelligent gas supply terminal p1 contains LNG intelligent gas supply terminal p4 other than the expanded gas supply point of the LNG intelligent gas supply terminal p1 in the terminal collection. The expanded gas supply area corresponding to the LNG intelligent gas supply terminal p2 contains LNG intelligent gas supply terminals p5 and p6 other than the expanded gas supply point of the LNG intelligent gas supply terminal p2.

The LNG intelligent gas supply terminals p4, p5, and p6 can be identified as extended gas supply points, and the count of extended gas supply points within the expanded gas supply area 230-4 and the expanded gas supply area 230-5 can be calculated as 1 and 2, respectively, thus the expanded gas supply areas are ranked. In accordance with the ranking, the sum of the count of extended gas supply points (LNG intelligent gas supply terminals p5 and p6) within the top-ranked expanded gas supply area 230-5 and the count of the plurality of LNG intelligent gas supply terminals in the initial coverage area 230-1 is calculated, and it is determined whether the sum is greater than the pre-set maximum density threshold p1 of the storage station A1.

In response to the sum being below the maximum density threshold p1, the extended gas supply points LNG intelligent gas supply terminals p5 and p6 within the expanded gas supply area 230-5 are added to the terminal collection of the storage station A1. In response to the sum being greater than the maximum density threshold p1, stop expanding the terminal collection of LNG storage stations.

As can be seen, the expanded gas supply area 230-4 and the expanded gas supply area 230-5 are expanded in different directions with respect to storage station A1. In some embodiments of the present disclosure, the expansion direction of the supply areas of the LNG storage stations can be optimized. Within the scope of the supply capacity of the LNG storage stations, the supply areas of the LNG storage stations can be expanded towards directions where the terminal density of LNG intelligent gas supply terminals is greater, which is conducive to improving the efficiency of LNG transportation and supply.

In some embodiments, the supply relationship network is dynamically updated when an update condition is met.

The update condition refers to the condition that needs to be satisfied when updating the supply relationship network.

In some embodiments, the update condition includes a time interval from the last update of the supply relationship network satisfying a pre-set condition.

In some embodiments, the pre-set condition may include being no less than a pre-set time period or the like.

In some embodiments, the update condition may also be that a pre-set trigger event exists for a future period of time after the LNG storage sub-strategy in each supply area has been executed respectively. The pre-set trigger event may include that more than a pre-set number of supply areas have situations of storage adjustments greater than a pre-set number of times. Situations of adjustable storage may include “insufficient storage” or “excess storage”, etc.

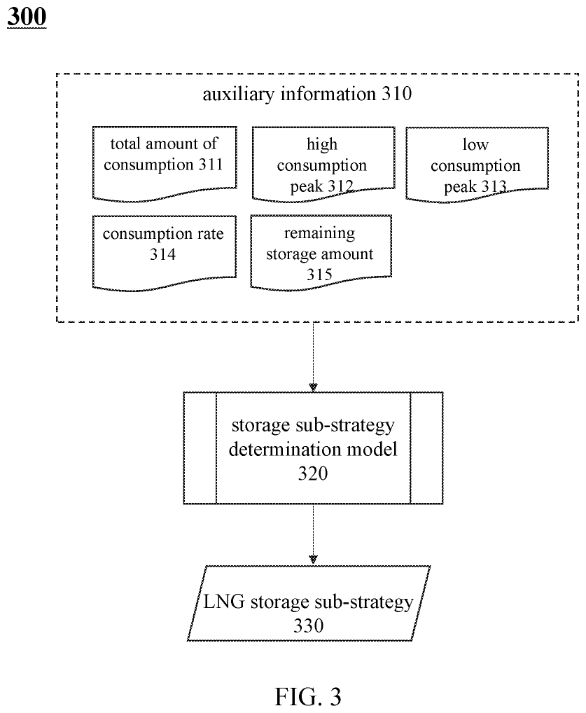

For more information about the LNG storage sub-strategy, please refer to FIG. 3 and its related descriptions.

In some embodiments, the method for dynamically updating the supply relationship network may refer to some or all of the methods for determining the supply relationship network described above.

The LNG distributed energy integrated management platform 630 may form a virtual pipeline network on the map through various feasible methods according to the supply relationship network. For example, based on the supply relationship network, the LNG distributed energy integrated management platform 630 may connect LNG intelligent supply terminals to an LNG storage station with a connected relationship through connecting lines to form a virtual pipeline network for LNG supply on a map.

In some embodiments of the present disclosure, the supply relationship network is determined according to the size characteristics of LNG storage stations and the gas consumption characteristics of LNG intelligent gas supply terminals. The virtual pipeline network is formed on the map based on the supply relationship network. In this way, forming the virtual pipeline network can be combined with the planning and building of LNG storage stations as well as the actual usage of LNG intelligent gas supply terminals, thus resulting in a more reasonable supply relationship, which is conducive to improving the efficiency of LNG management.

FIG. 3 is an exemplary schematic diagram of a storage sub-strategy determination model according to some embodiments of the present disclosure;

In some embodiments, the LNG storage strategies include an LNG storage sub-strategy for each supply area.

The LNG storage sub-strategy refers to the storage strategy of a single LNG storage station.

In some embodiments, the LNG storage sub-strategy includes at least a pre-set frequency of LNG replenishment and an amount of each replenishment for a future time interval.

In some embodiments, the LNG distributed energy integrated management platform 630 may determine an LNG storage sub-strategy 330 for each supply area based on auxiliary information 310.

See FIG. 1 and its associated descriptions for more on supply areas.

Auxiliary information refers to data or information related to the LNG storage sub-strategy. For example, holidays, policies and regulations, etc.

In some embodiments, the auxiliary information 310 includes at least one of a total amount of consumption 311, a high consumption peak 312, a low consumption peak 313, a consumption rate 314, and a remaining storage amount 315 of LNG in each supply area.

For more information on the total amount of consumption, high consumption peaks, low consumption peaks, consumption rates, and remaining storage amount, see FIG. 1 and its related descriptions.

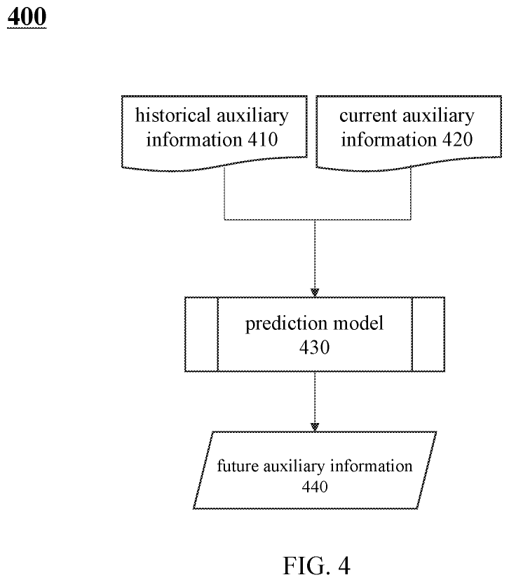

In some embodiments, the auxiliary information 310 includes historical auxiliary information, current auxiliary information, and future auxiliary information. For more information about auxiliary information, see FIG. 4 and its related descriptions.

The LNG distributed energy integrated management platform 630 may determine the LNG storage sub-strategy 330 for each supply area through various feasible methods based on the auxiliary information 310. For example, based on the auxiliary information, the LNG storage sub-strategy for each supply area may be determined through a mapping table between the auxiliary information and the LNG storage sub-strategy.

In some embodiments, the LNG distributed energy integrated management platform 630 may process the auxiliary information 310 through the storage sub-strategy determination model 320 to determine at least one LNG storage sub-strategy 330 in one supply area. The storage sub-strategy determination model 320 may be a machine learning model. For example, the storage sub-strategy determination model 320 may be a neural network model, a deep neural network, or any combination thereof.

The storage sub-strategy determination model is a model for determining the LNG storage sub-strategy.

In some embodiments, the storage sub-strategy determination model 320 may be obtained by training a large number of first training samples with first labels. In some embodiments, the first training samples may be sample auxiliary information, and the first training samples may be obtained based on historical data. The first labels may be the sample LNG storage sub-strategy corresponding to the first training samples. In some embodiments, for a supply area, after a certain LNG storage sub-strategy is selected based on a set of first training samples corresponding to the total amount of consumption, high consumption peaks, low consumption peaks, consumption rates, and a remaining storage amount, and in response to the LNG remaining storage amount of a plurality of future times being within a reasonable range (the reasonable range can be set empirically), the LNG storage sub-strategy is identified as the sample LNG storage sub-strategy corresponding to a first training sample.

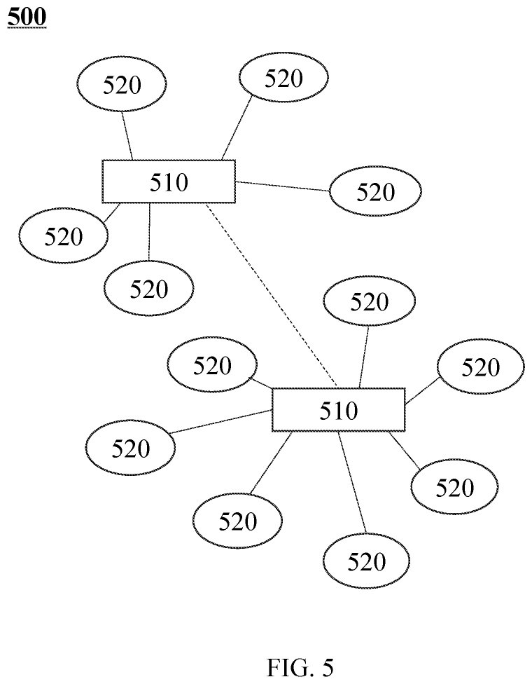

In some embodiments, the LNG distributed energy integrated management platform 630 may input the virtual pipeline network map containing the supply relationship network into the linked storage strategy determination model. The linked storage strategy determination model outputs an LNG storage sub-strategy for each node of the LNG storage station. For more information about the linked storage strategy determination model, please refer to FIG. 5 and its related descriptions.

In some embodiments of the present disclosure, by determining the LNG storage sub-strategy for each supply area based on auxiliary information, the corresponding LNG storage sub-strategy for each supply area forms the overall LNG storage strategies, enabling the LNG storage sub-strategy for different supply areas to be developed according to the LNG consumption of that supply area respectively, thus producing more reasonable storage strategies and better satisfying the LNG demand of each supply area.

FIG. 4 is an exemplary schematic diagram of a prediction model according to some embodiments of the present disclosure.

In some embodiments, the auxiliary information includes historical auxiliary information 410, current auxiliary information 420, and future auxiliary information 440.

In some embodiments, referring to the method relating to step 150 in FIG. 1 above, the LNG distributed energy integrated management platform 630 may obtain the historical auxiliary information 410 and the current auxiliary information 420 by statistically analyzing the data collected by the LNG intelligent gas supply terminals and the storage volume data of the LNG storage stations during the historical time periods and the pre-set current time periods respectively.

The future auxiliary information refers to auxiliary information in a future time period. The LNG distributed energy integrated management platform 630 may obtain future auxiliary information through various feasible methods. For example, for each supply area, a plurality of historical auxiliary information and current auxiliary information, as well as the time periods corresponding to the aforementioned information, can be obtained. The fitting relationships between auxiliary information and the time periods can be obtained by fitting the plurality of historical auxiliary information, current auxiliary information, and time periods. Based on the future time periods, the future auxiliary information, etc. can be obtained based on the fitting relationships.

As another example, future auxiliary information can also be obtained through predictions using the Dragonfly Algorithm or the like.

In some embodiments, the LNG distributed energy integrated management platform 630 may process historical auxiliary information 410 and current auxiliary information 420 for at least one LNG supply area through a prediction model 430 and determine future auxiliary information 440 for at least one LNG supply area. The prediction model 430 may be a machine learning model. For example, the prediction model may be a recurrent neural network (RNN) model, a long short-term memory network (LSTM), etc.

In some embodiments, the input of the prediction model 430 may include historical auxiliary information 410 and current auxiliary information 420 of at least one LNG supply area, and the output may be future auxiliary information 440 of at least one supply area.

In some embodiments, the prediction model 430 can be obtained by training a large number of second training samples with a second label. In some embodiments, the second training samples may include the sample history auxiliary information and the sample current auxiliary information for at least one LNG supply area, and the second label may be the sample future auxiliary information for at least one LNG supply area. The second training samples may be obtained based on historical data. The actual auxiliary information at time periods subsequent to the historical time periods may be obtained based on the historical time periods corresponding to the second training samples. The second label may be marked based on the aforementioned actual auxiliary information.

In some embodiments of the present disclosure, the auxiliary information is expanded to take into account historical auxiliary information, current auxiliary information, and future auxiliary information. Subsequently, the LNG storage sub-strategy for at least one supply area is determined based on the auxiliary information, which takes into account not only the current LNG consumption but also the possible impact of historical consumption and predicted future consumption on the LNG storage sub-strategy, making the determination of the LNG storage sub-strategy more reasonable and better adapted to possible changes in actual scenarios.

FIG. 5 is an exemplary schematic diagram of a virtual pipeline network according to some embodiments of the present disclosure.

In some embodiments, the LNG distributed energy integrated management platform 630 may input the virtual pipeline network map 500 containing the supply relationship network into the linked storage strategy determination model. The linked storage strategy determination model outputs an LNG storage sub-strategy for each node of the LNG storage station.

The virtual pipeline network map refers to the graphical structure of the virtual pipeline network. The LNG distributed energy integrated management platform 630 may obtain the virtual pipeline network map 500 by performing data processing and modeling on the virtual pipeline network. In some embodiments, the LNG distributed energy integrated management platform 630 may convert and store the virtual pipeline network into a virtual pipeline network map with certain data structures (e.g., adjacency matrix, adjacency table, etc.) based on the virtual pipeline network that maps the supply relationship and the geographic location information of the LNG storage stations and the LNG intelligent gas supply terminals.

In some embodiments, in the virtual pipeline network map 500, as shown in FIG. 5, the nodes may include an LNG storage station node 510, an LNG intelligent gas supply terminal node 520, etc. Exemplarily, the node characteristics of the LNG storage station node 510 may include size characteristics. Exemplarily, the node characteristics of the LNG intelligent gas supply terminal node 520 may include gas consumption characteristics, categories of users, environmental characteristics, etc. Environmental characteristics may include time points, seasons, types of areas, etc. For more information on size characteristics, gas consumption characteristics, and categories of users, please refer to FIG. 2 and its related descriptions.

In some embodiments, edges of a virtual pipeline network map may include connecting edges of LNG storage station nodes and LNG intelligent gas supply terminal nodes for which a supply relationship exists, and connecting edges of LNG storage station nodes and LNG storage station nodes that are relatively close (e.g., less than a distance threshold, etc.) or have a relatively short transportation time (e.g., less than a transportation time threshold, etc.). Exemplarily, the edge characteristics may include distance, transmission time, etc.

The linked storage strategy determination model is a model for determining the LNG storage sub-strategy for at least one LNG storage station in conjunction with a plurality of LNG storage stations and LNG intelligent gas supply terminal nodes.

The linked storage strategy determination model is a trained machine learning model. The linked storage strategy determination model may include other models. For example, any one or combination of a recurrent neural network model, a convolutional neural network, or other customized model structures, etc.

In some embodiments, the linked storage strategy determination model may include a graph neural network (GNN) model. In some embodiments, the LNG distributed energy integrated management platform 630 may obtain a virtual pipeline network map by data processing and modeling of the virtual pipeline network, input the virtual pipeline network map into a linked storage strategy determination model, and determine an LNG storage sub-strategy for an LNG storage station node based on the output of the LNG storage station node.

In some embodiments, the linked storage strategy determination model may be obtained through training. The training samples include a large number of third training samples with a third label and are obtained through training. The third training samples may be sample virtual pipeline network maps, and the third label may be an LNG storage sub-strategy of the corresponding LNG storage station nodes. The third label may be marked manually. The LNG distributed energy integrated management platform 630 maximizes the prediction accuracy of the training data by iteratively optimizing the characteristic representations of nodes and edges when training the initial graph neural network model and updates the parameters of the graph neural network model to obtain a trained model for determining the linked storage strategy.

In some embodiments of the present disclosure, the linked storage strategy determination model is configured to determine the LNG storage sub-strategies of LNG storage station nodes, realizing the coordination and management of linked storage. When the storage balance of an LNG storage station is insufficient, LNG can be dispatched from other LNG storage stations with richer balances, which can effectively improve the LNG supply efficiency while avoiding overloading LNG storage stations.

FIG. 6 is an exemplary schematic diagram of an Internet of Things system for dynamically adjusting LNG storage based on big data according to some embodiments of the present disclosure.

An Internet of Things (IoT) system for dynamic adjustment of LNG storage based on big data, in order to build a multi-object composite Internet of Things system for the linkage management of LNG distributed energy storage and gas consumption, that is, the LNG distributed energy operator user platform is coordinated through the same management platform, which forms a different information operation closed loop with the storage object platform and the intelligent terminal object platform, realizing the information linkage management of the two information operation closed loops.

In some embodiments, an IoT system 600 for dynamically adjusting LNG storage based on big data may include an LNG distributed energy operator user platform 610, an LNG distributed energy service platform 620, an LNG distributed energy integrated management platform 630, a plurality of sensing network platforms, and a plurality of object platforms. The LNG distributed energy operator user platform 610, the LNG distributed energy service platform 620, the LNG distributed energy integrated management platform 630, the plurality of sensor network platforms, and the plurality of object platforms are connected in sequence to each other in communication.

In some embodiments, the LNG distributed energy operator user platform 610 is used by the operator user to obtain LNG storage sensing information and LNG consumption sensing information and to release corresponding control information as required.

In some embodiments, the LNG distributed energy service platform 620 is a server, which connects the LNG distributed energy operator user platform 610 and the LNG distributed energy integrated management platform 630 through a communication network.

In some embodiments, the LNG distributed energy integrated management platform 630 is configured to call LNG storage information and LNG consumption information, and through centralized calculation of big data, comprehensively analyze the total amount of LNG consumption, high consumption peaks, low consumption peaks, consumption rates, and the remaining storage amount of LNG in different areas to form LNG storage strategies.

In some embodiments, the LNG distributed energy integrated management platform 630 includes an LNG distributed energy storage management sub-platform, an LNG distributed energy intelligent terminal management sub-platform, and a management database.

In some embodiments, the LNG distributed energy storage management sub-platform and the LNG distributed energy storage object platform form a closed loop of storage information, obtaining the geographical point distributions and the storage volumes of LNG storage, and storing the data in the management database after processing.

In some embodiments, the LNG distributed energy intelligent terminal management sub-platform and the LNG distributed energy intelligent terminal object platform form a closed loop of LNG consumption management information, obtaining information on LNG consumption and usage, and storing the data in the management database after processing.

In some embodiments, the sensing network platform includes an LNG distributed energy storage sensing network platform 640 and an LNG distributed energy intelligent terminal sensing network platform 650.

In some embodiments, the LNG distributed energy storage sensing network platform 640 is connected to the LNG distributed energy storage object platform 660 for achieving a communication connection between the LNG distributed energy integrated management platform 630 and the LNG distributed energy storage object platform 660 by means of a sensing communication network.

In some embodiments, the LNG distributed energy intelligent terminal sensing network platform 650 is connected to the LNG distributed energy intelligent terminal object platform 670 for achieving a communication connection between the LNG distributed energy integrated management platform 630 and the LNG distributed energy intelligent terminal object platform 670 by means of the sensing communication network.

In some embodiments, the sensing communication network of the sensing network platform comprises 5G, the Internet, GPS, and Beidou satellites.

In some embodiments, the object platform includes an LNG distributed energy storage object platform 660 and an LNG distributed energy intelligent terminal object platform 670, for collecting and uploading sensing information from storages and intelligent gas supply terminals, and for executing control commands corresponding to LNG storage strategies formed by the LNG distributed energy integrated management platform 630.

In some embodiments, the LNG distributed energy storage object platform 660 includes intelligent storage devices that acquire and upload storage sensing information and execute storage control commands from the management platform through an internally loaded information system.

In some embodiments, the LNG distributed energy intelligent terminal object platform 670 is an intelligent device with LNG virtual pipeline network end storage, vaporization, and metering functions, which uploads LNG storage information, usage information, device operation status information, and safety information through the internally loaded information system, and executes control commands of the management platform.

It should be noted that the above description of the Internet of Things system for dynamically adjusting LNG storage based on big data and its platforms and modules is only for the convenience of description and does not limit the present disclosure to the scope of the examples cited. It should be understood that it is possible for a person skilled in the art, with an understanding of the principle of the system, to make any combination of platforms and modules, or to form sub-systems to connect to other platforms and modules, without departing from this principle. For example, the LNG distributed energy storage sensing network platform and the LNG distributed energy storage object platform disclosed in FIG. 6 may be different platforms in one system, or alternatively, one platform may implement the functions of two or more platforms mentioned above. For example, each platform may share one storage module, or each platform may have its own storage module. Such variations are within the protection scope of the present disclosure.

One or more embodiments of the present disclosure provide a non-transitory computer-readable storage medium, which stores computer commands, and when the computer reads the computer commands in the storage medium, the computer executes the aforementioned method of dynamically adjusting LNG storage based on big data.

The basic concepts have been described above, and it is clear that the above-detailed disclosure is intended as an example only for those skilled in the art and does not constitute a limitation of the present disclosure. Although not expressly stated here, those skilled in the art may make various modifications, improvements, and corrections to this description. Such modifications, improvements, and corrections are suggested in the present disclosure, so such modifications, improvements, and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure, or characteristic related to at least one embodiment of the present disclosure. Therefore, it should be emphasized and noted that two or more references to “an embodiment” or “an embodiment” or “an alternative embodiment” in different places in the present disclosure do not necessarily refer to the same embodiment. In addition, certain features, structures or characteristics in one or more embodiments of the present disclosure may be properly combined.

In addition, unless explicitly stated in the claims, the order of processing elements and sequences described in the present disclosure, the use of numbers and letters, or the use of other names are not used to limit the sequence of processes and methods in the present disclosure. While the foregoing disclosure has discussed by way of various examples some embodiments of the invention that are presently believed to be useful, it should be understood that such details are for illustrative purposes only and that the appended claims are not limited to the disclosed embodiments, but rather, the claims are intended to cover all modifications and equivalent combinations that fall within the spirit and scope of the embodiments of the present disclosure. For example, although the system components described above may be implemented by hardware devices, they may also be implemented by a software-only solution, such as installing the described system on an existing server or mobile device.

In the same way, it should be noted that in order to simplify the expression disclosed in the present disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Indeed, embodiment features are less than all features of a single foregoing disclosed embodiment.

In some embodiments, numbers describing the quantity of components and attributes are used. It should be understood that such numbers used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should take into account the specified significant digits and adopt the general digit reservation method. Although the numerical ranges and parameters used in some embodiments of the present disclosure to confirm the breadth of the range are approximations, in specific embodiments, such numerical values are set as precisely as practicable.

Each patent, patent application, patent application publication, and other material, such as article, book, disclosure, publication, document, etc., cited in the present disclosure is hereby incorporated by reference in its entirety. Application history documents that are inconsistent with or conflict with the content of the present disclosure are excluded, and documents (currently or later appended to the present disclosure) that limit the broadest scope of the claims of the present disclosure are excluded. It should be noted that if there is any inconsistency or conflict between the descriptions, definitions, and/or terms used in the accompanying materials of this manual and the contents of this manual, the descriptions, definitions and/or terms used in this manual shall prevail.

Finally, it should be understood that the embodiments described in the present disclosure are only used to illustrate the principles of the embodiments of the present disclosure. Other modifications are also possible within the scope of this description. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A method for dynamically adjusting liquefied natural gas (LNG) storage based on big data, comprising the following steps:
step 1: setting up LNG intelligent gas supply terminals at gas supply points of all users to collect real-time LNG storage data and uploading the real-time LNG storage data through a wireless sensing network;
step 2: monitoring LNG storage stations in real-time, and uploading the storage volume data through the wireless sensor network;
step 3: importing geographical location information of the LNG storage stations and the LNG intelligent gas supply terminals into a geographic information system (GIS) map, and forming a virtual pipeline network for LNG supply according to a geographic location relationship between the LNG storage stations and the LNG intelligent gas supply terminals;
step 4: dividing supply areas with the LNG storage stations as the centers according to the virtual pipeline network on the map; and
step 5: by statistically analyzing data collected by the LNG intelligent gas supply terminals and the storage volume data of the LNG storage stations, obtaining a total amount of consumption, high consumption peaks, low consumption peaks, consumption rates, and a remaining storage amount of LNG in different supply areas, so as to form LNG storage strategies.

2. The method for dynamically adjusting LNG storage based on big data according to claim 1, wherein the virtual pipeline network in step 3 is configured to map a supply relationship between the LNG storage stations and the LNG intelligent gas supply terminals.

3. The method for dynamically adjusting LNG storage based on big data according to claim 1, wherein step 3 further comprises the following sub-steps:
step 301: obtaining the geographic location information of all the LNG storage stations and the LNG intelligent gas supply terminals and importing them into the GIS map; and
step 302: locating an LNG storage station with a shortest route to the LNG intelligent gas supply terminals, and connecting this LNG storage station to the LNG intelligent gas supply terminals via routes on the GIS map, thereby forming the virtual pipeline network on the map for LNG supply.

4. The method for dynamically adjusting LNG storage based on big data according to claim 1, wherein step 3 further comprises the following sub-steps:
step 301: obtaining the geographic location information of all the LNG storage stations and the LNG intelligent gas supply terminals and importing them into the GIS map; and
step 302: locating the LNG storage station with a shortest route to the LNG intelligent gas supply terminals, and connecting this LNG storage station to the LNG intelligent gas supply terminals via routes on the GIS map, thereby forming the virtual pipeline network on the map for LNG supply.

5. The method for dynamically adjusting LNG storage based on big data according to claim 1, wherein step 3 further comprises:
determining a supply relationship network according to the size characteristics of each LNG storage station and gas consumption characteristics of each LNG intelligent gas supply terminal, wherein the supply relationship network comprises a gas supply storage station corresponding to each LNG intelligent gas supply terminal; and
forming the virtual pipeline network on the map according to the supply relationship network.

6. The method for dynamically adjusting LNG storage based on big data according to claim 5, wherein the supply relationship network is dynamically updated when an update condition is met; wherein the update condition includes a time interval from the last update of the supply relationship network satisfying a pre-set condition.

7. The method for dynamically adjusting LNG storage based on big data according to claim 1, wherein the LNG storage strategies comprise an LNG storage sub-strategy for each supply area, and the LNG storage sub-strategy comprising at least a pre-set frequency of LNG replenishment and an amount of each replenishment for a future time interval;
the determining of an LNG storage sub-strategy for each of the supply areas comprises: determining the LNG storage sub-strategy for each supply area based on auxiliary information; the auxiliary information comprising at least one of the total amount of consumption, high consumption peaks, low consumption peaks, consumption rates, and the remaining storage amount of LNG in each supply area.

8. The method for dynamically adjusting LNG storage based on big data according to claim 7, wherein the determining of an LNG storage sub-strategy for each of the supply areas further comprises:
determining an LNG storage sub-strategy for at least one supply area by processing the auxiliary information via a storage sub-strategy determination model, the storage sub-strategy determination model being a machine learning model.

9. The method for dynamically adjusting LNG storage based on big data according to claim 7, wherein the auxiliary information comprises historical auxiliary information, current auxiliary information, and future auxiliary information.

10. An Internet of Things (IoT) system for dynamically adjusting liquefied natural gas (LNG) storage based on big data, employing the method for dynamically adjusting LNG storage based on big data according to claim 1, wherein the system comprises an LNG distributed energy operator user platform, an LNG distributed energy service platform, an LNG distributed energy integrated management platform, a plurality of sensing network platforms, and a plurality of object platforms; the LNG distributed energy operator user platform, the LNG distributed energy service platform, the LNG distributed energy integrated management platform, the plurality of sensing network platforms, and the plurality of object platforms are connected in sequence to each other in communication;
the LNG distributed energy operator user platform is configured for operator users to obtain LNG storage sensing information and LNG consumption sensing information, and to release corresponding control information as required;
the LNG distributed energy service platform is a server, which connects the LNG distributed energy operator user platform and the LNG distributed energy integrated management platform through a communication network;
the LNG distributed energy integrated management platform is configured to call LNG storage information and LNG consumption information, and through centralized calculation of big data, comprehensively analyze the total amount of LNG consumption, high consumption peaks, low consumption peaks, consumption rates, and the remaining storage amount of LNG in different areas to form LNG storage strategies;
the sensing network platform comprises an LNG distributed energy storage sensing network platform and an LNG distributed energy intelligent terminal sensing network platform;
the LNG distributed energy storage sensing network platform is connected to the LNG distributed energy storage object platform for achieving a communication connection between the LNG distributed energy integrated management platform and the LNG distributed energy storage object platform by means of a sensing communication network;
the LNG distributed energy intelligent terminal sensing network platform is connected to the LNG distributed energy intelligent terminal object platform for achieving a communication connection between the LNG distributed energy integrated management platform and the LNG distributed energy intelligent terminal object platform by means of the sensing communication network;
the object platform comprises the LNG distributed energy storage object platform and the LNG distributed energy intelligent terminal object platform; the object platform is used for collecting and uploading sensing information of storages and intelligent gas supply terminals, and for executing control commands corresponding to the LNG storage strategies formed by the LNG distributed energy integrated management platform.

11. The IoT system for dynamically adjusting LNG storage based on big data according to claim 10, wherein the LNG distributed energy integrated management platform comprises an LNG distributed energy storage management sub-platform, an LNG distributed energy intelligent terminal management sub-platform, and a management database; the LNG distributed energy storage management sub-platform forms a closed loop of storage information with the LNG distributed energy storage object platform, obtains geographical distributions of LNG storage locations and storage volumes, and stores the data in the management database after processing; and the LNG distributed energy intelligent terminal management sub-platform forms a closed loop of LNG consumption management information with the LNG distributed energy intelligent terminal object platform, obtains information on LNG consumption, and stores the data in the management database after processing.

12. The IoT system for dynamically adjusting LNG storage based on big data according to claim 10, wherein the sensing communication network of the sensing network platform comprises 5G, the Internet, GPS, and Beidou satellites.

13. The IoT system for dynamically adjusting LNG storage based on big data according to claim 10, wherein the LNG distributed energy storage object platform comprises intelligent storage devices that acquire and upload storage sensing information and execute storage control commands from the management platform through an internally loaded information system.

14. The IoT system for dynamically adjusting LNG storage based on big data according to claim 10, wherein the intelligent terminal object platform is an intelligent device with LNG virtual pipeline network end storage, vaporization, and metering functions, which uploads LNG storage information, usage information, device operation status information, and safety information through the internally loaded information system, and executes control commands of the management platform.

15. The IoT system for dynamically adjusting LNG storage based on big data according to claim 10, wherein the LNG distributed energy integrated management platform is further configured to perform the following operations:
determining a supply relationship network according to size characteristics of each LNG storage station and gas consumption characteristics of each LNG intelligent gas supply terminal, wherein the supply relationship network comprises a gas supply storage station corresponding to each LNG intelligent gas supply terminal; and
forming a virtual pipeline network on the map based on the supply relationship network.

16. The IoT system for dynamically adjusting LNG storage based on big data according to claim 15, wherein the LNG distributed energy integrated management platform is further configured to perform the following operations:
updating the supply relationship network dynamically when an update condition is met; wherein the update condition includes a time interval from the last update of the supply relationship network satisfying a pre-set condition.

17. The IoT system for dynamically adjusting LNG storage based on big data according to claim 10, wherein the LNG storage strategies comprise an LNG storage sub-strategy for each supply area, the LNG storage sub-strategy comprising at least a pre-set frequency of LNG replenishment and an amount of each replenishment of LNG for a future time interval;
the LNG distributed energy integrated management platform is further configured to perform the following operations:
determining the LNG storage sub-strategy for each of supply areas based on auxiliary information; the auxiliary information comprising at least one of the total amount of consumption, high consumption peaks, low consumption peaks, consumption rates, and a remaining storage amount of LNG in each supply area.

18. The IoT system for dynamically adjusting LNG storage based on big data according to claim 17, wherein the LNG distributed energy integrated management platform is further configured to perform the following operations:
determining an LNG storage sub-strategy for at least one supply area by processing the auxiliary information through a storage sub-strategy determination model, wherein the storage sub-strategy determination model is a machine learning model.

19. The IoT system for dynamically adjusting LNG storage based on big data according to claim 17, wherein the auxiliary information comprises historical auxiliary information, current auxiliary information, and future auxiliary information.

20. A non-transitory computer-readable storage medium, wherein the storage medium stores computer commands, and when the computer reads the computer commands in the storage medium, the computer executes the method of dynamically adjusting liquefied natural gas (LNG) storage based on big data as claimed in claim 1.
